(19) United States
(12) Patent Application Publication
(10) Pub. No.: US 2015/0161895 A1
(43) Pub. Date: Jun. 11, 2015

(54) LANE CHANGE CONTROL APPARATUS AND CONTROL METHOD OF THE SAME

(71) Applicant: HYUNDAI MOTOR COMPANY, Seoul (KR)

(72) Inventors: Byung Yong YOU, Suwon-si (KR); Chang Young JUNG, Busan (KR)

(21) Appl. No.: 14/297,250

(22) Filed: Jun. 5, 2014

(30) Foreign Application Priority Data
Dec. 11, 2013 (KR) 10-2013-0154038

(51) Int. Cl. G08G 1/16; B60W 30/12

(52) U.S. Cl. CPC G08G 1/167; B60W 30/12; B60W 2520/10; B60W 2520/28; B60W 2540/18; B60W 2720/14

(57) ABSTRACT

A lane change control apparatus includes a lane information extractor configured to obtain lane information for a driving lane by using image information for a lane. A lane changeable time calculator is configured to calculate a lane changeable time by using speed information of an own vehicle and information for peripheral vehicles obtained from sensing apparatuses installed in the vehicle. A reference yaw rate generator is configured to determine a lane change time by using the lane changeable time and speed information and generate a reference yaw rate symmetrically changed on a time axis during the lane change time by using the lane change time and lane information. A reference yaw rate tracker is configured to control an operation of the own vehicle so as to track the reference yaw rate.

### CROSS-REFERENCE TO RELATED APPLICATION

This application is based on and claims the benefit of priority to Korean Patent Application No. 10-2013-0154038, filed on Dec. 11, 2013 in the Korean Intellectual Property Office, the disclosure of which is incorporated herein in its entirety by reference.

### TECHNICAL FIELD

The present disclosure relates to an apparatus of automatically changing a lane of a vehicle and a method thereof, and more particularly, to a lane change control apparatus generating a reference yaw rate having symmetry on a time axis according to a driving state of a vehicle and a surrounding environment thereof and changing a lane by tracking the reference yaw rate, and a control method of the same.

### BACKGROUND

In recent years, a research into an autonomous navigation vehicle has been accelerated, and it is expected to mass-produce the vehicle capable of partially or automatically implementing an autonomous navigation on a highway within 2020. In order to perform the autonomous navigation on the highway, an automatic lane change is necessary. According to the related art, a method for changing the lane as described above includes a method of generating a path for changing the lane and tracking the corresponding path.

However, the above-mentioned path tracking method needs to estimate a vehicle position. The related art mainly uses a dead reckoning and uses a vehicle dynamics model. Thus, there need many parameters to be set in advance, thus creating a complexity. Particularly, in order to accurately measure a parameter, a cumbersome process called system identification for each vehicle needs to be performed.

### SUMMARY

The present disclosure has been made to solve the above-mentioned problems occurring in the prior art while advantages achieved by the prior art are maintained intact.

An aspect of the present disclosure provides a method capable of simply changing a lane without performing a cumbersome process such as a system identification.

According to an exemplary embodiment of the present disclosure, a lane change control apparatus includes a lane information extractor configured to obtain lane information for a driving lane by using image information for a lane. A lane changeable time calculator is configured to calculate a lane changeable time by using speed information of an own vehicle and information for peripheral vehicles obtained by sensing apparatuses installed in the own vehicle. A reference yaw rate generator is configured to determine a lane change time by using the lane changeable time and the speed information and generate a reference yaw rate symmetrically changed on a time axis during the lane change time by using the lane changeable time and the lane information. A reference yaw rate tracker is configured to control an operation of the own vehicle so as to track the reference yaw rate.

According to another exemplary embodiment of the present disclosure, a lane change control method of a vehicle includes obtaining lane information by using image information of a lane and obtaining speed information of an own vehicle and relative speeds and distances between peripheral vehicles and the own vehicle by using information from sensing apparatuses installed in the own vehicle. A lane changeable time is calculated by using the relative speeds and the distances. A lane change time is determined by using the lane changeable time and speed information of the own vehicle, and a reference yaw rate symmetrically changed is generated on an time axis during the lane change time by using the lane change time and lane information. An operation of the own vehicle is controlled so as to track the reference yaw rate.

### BRIEF DESCRIPTION OF THE DRAWINGS

The above and other objects, features and advantages of the present disclosure will be more apparent from the following detailed description taken in conjunction with the accompanying drawings.

FIG. 1 shows a configuration view of a configuration of a lane change control apparatus according to an exemplary embodiment of the present disclosure.

FIG. 2 shows exemplary graph views of yaw rate values of a vehicle according to time variations when the vehicle substantially changes a lane according to an exemplary embodiment of the present disclosure.

FIG. 3 describes a flow chart for a lane change control method according to an exemplary embodiment of the present disclosure.

FIGS. 4A to 4C show exemplary views of drive shapes of a vehicle according to a reference yaw rate tracking according to an exemplary embodiment of the present disclosure.

### DETAILED DESCRIPTION

Hereinafter, exemplary embodiments of the present disclosure will be described in detail with reference to the accompanying drawings. The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure. Therefore, the configurations described in the embodiments and drawings of the present disclosure are merely most preferable embodiments but do not represent all of the technical spirit of the present disclosure. Thus, the present disclosure should be construed as including all the changes, equivalents, and substitutions included in the spirit and scope of the present disclosure at the time of filing this application.

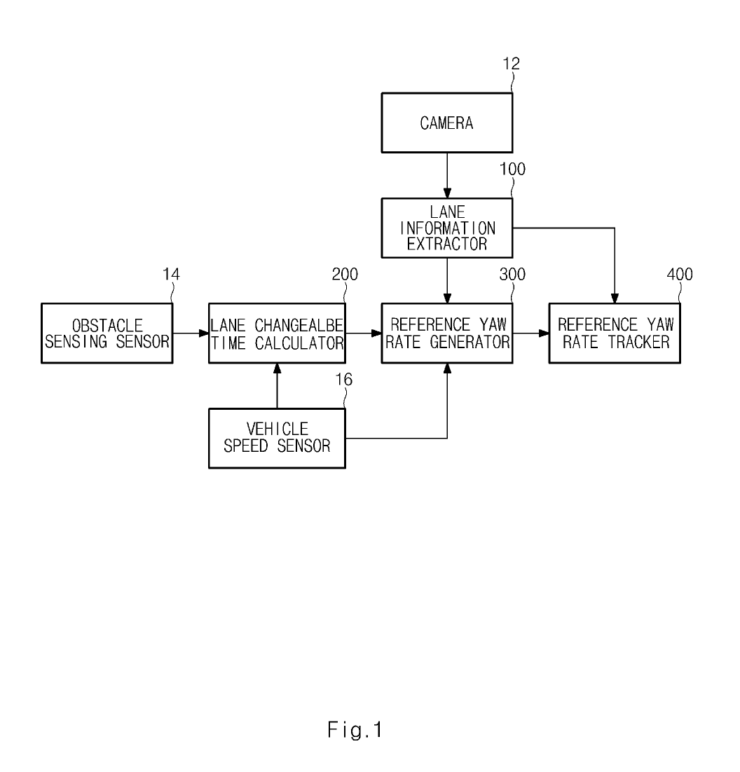

FIG. 1 shows a configuration of a lane change control apparatus according to an exemplary embodiment of the present disclosure. A lane change control apparatus according to an exemplary embodiment of the present disclosure may include a lane information extractor 100, a lane changeable time calculator 200, a reference yaw rate generator 300, and a reference yaw rate tracker 400.

The lane information extractor 100 processes image information for a front road obtained by a camera 12 to thereby calculate information, such as, lane information, a lane width, and a curvature, for a lane on which an own vehicle drives. In addition, the lane information extractor 100 processes the image information for the front road obtained by the camera 12 to thereby detect a vehicle position on a current lane.

The lane changeable time calculator 200 calculates a lane changeable time by using a driving speed of an own vehicle and information for peripheral vehicles. For example, the lane changeable time calculator 200 senses information for the peripheral vehicles and speed information of the own vehicle by an obstacle sensing sensor 14 (e.g., a RiDAR sensor, a radar sensor, an ultrasonic sensor, or the like) and a vehicle speed sensor 16 and calculates a relative speed of the own vehicle and a peripheral vehicle in front of the lane (a driving lane) on which the own vehicle drives and a distance between the own vehicle and the peripheral vehicle in the front of the driving lane, and relative speeds of the own vehicle and peripheral vehicles in front and back of a lane (a target lane) to be changed and distances between the own vehicle and the peripheral vehicles in the front and back of the target lane using the sensed information. In addition, the lane changeable time calculator 200 calculates a time capable of safely changing the lane without being collided with the front vehicle on the driving lane and the front and back vehicles on the target lane based on the above-mentioned information. In this case, the lane changeable time calculator 200 may determine safety for changing the lane using a minimum safety spacing (MMS) algorithm or a time to collision (TTC) algorithm and calculate the time capable of safely changing the lane. The lane changeable time calculator 200 compares the calculated lane changeable time with a preset threshold value and continuously checks the driving speed of the own vehicle and information for the peripheral vehicles when the lane changeable time is smaller than the threshold value to thereby repetitively perform the calculation for the lane changeable time. When the lane changeable time becomes larger than the threshold value through the above-mentioned repetitive calculation, the lane changeable time calculator 200 transmits information for the lane changeable time to the reference yaw rate generator 300.

The reference yaw rate generator 300 generates a reference yaw rate using the lane changeable time from the lane changeable time calculator 200, the lane information from the lane information extractor 100, and the speed information from the vehicle speed sensor 16. For example, the reference yaw rate generator 300 determines a time (a lane change time) necessary to change the lane at a current speed using the lane changeable time and speed information, and determines the yaw rate using the lane changeable time and lane information to allow the yaw rate to be symmetrically changed on a time axis during the lane change time. In this case, the lane change time may be variably set according to the vehicle speed or may be pre-set to a specific value, for example, the threshold used in the lane changeable time calculator 200.

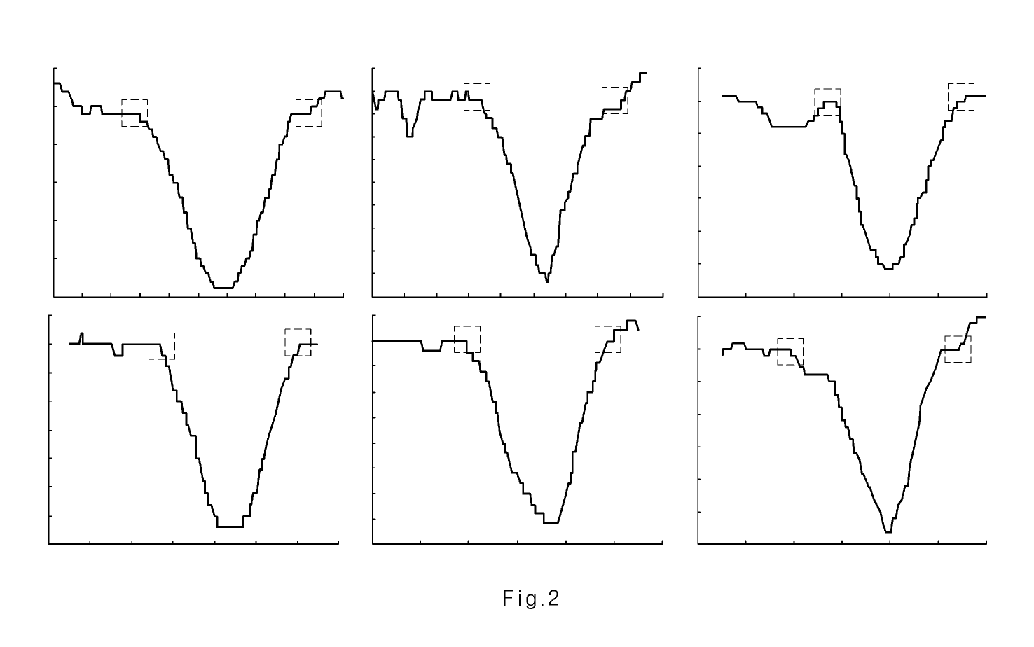

FIG. 2 is a graph view exemplarily showing yaw rate values of a vehicle according to time variations when the vehicle substantially changes a lane. As a result of analyzing a movement of the own vehicle by analyzing drive data when the lane is substantially changed, it may be appreciated that the movement of the own vehicle is symmetric according to a time as shown in FIG. 2. That is, assuming that the driving lane has the same width as the target lane, it may be appreciated that a yaw rate during the lane change and a yaw rate when a position (steering) of the own vehicle is restored to drive normally in the target lane after changing the lane may have the same value except when they have opposite signs (+, −). Therefore, the reference yaw rate generator 300 may generate the reference yaw rate by calculating (or extracting) the yaw rate using lane information, a vehicle speed (a constant speed, acceleration, deceleration) and the lane change time, by applying the yaw rate to a direction (+) of the target lane during a half time of the lane change time to change the lane, and then applying the same yaw rate to an opposite direction (−) during the remaining half time to again restore the driving direction (steering) of the own vehicle in the target lane. For example, in the case in which it is desired to change the lane to a right lane, and the lane change time is 10 seconds, the reference yaw rate generator 300 applies a positive (+) value indicating a right direction to the yaw rate during 5 seconds and applies a negative (−) value indicating a left direction to the yaw rate during next 5 seconds. In this case, the reference yaw rate generator 300 may generate the reference yaw rate so that the driving path of the own vehicle has a sine wave shape. For example, assuming that the driving lane and the target lane have the same width, the reference yaw rate generator 300 may generate the reference yaw rate so that the own vehicle may drive along the sine wave shape having amplitude as the lane width and a half of period as the lane change time. Alternatively, after the reference yaw rates suitable for the vehicle speed, the lane change time, and the curvature are pre-determined and built in a database by measuring driving data when the lane is substantially changed, the reference yaw rate generator 300 may select any one reference yaw rate corresponding to current state information (the speed, the lane change time, and the curvature). As such, the yaw rate symmetrically determined on the time axis for the lane change time becomes the reference yaw rate, which is transmitted to the reference yaw rate tracker 400.

The reference yaw rate tracker 400 controls the drive of the own vehicle so as to robustly track the reference yaw rate transmitted from the reference yaw rate generator 300. For example, the reference yaw rate tracker 400 controls the driving of the own vehicle while continuously monitoring whether or not the vehicle changes the lane by moving normally according to the reference yaw rate, and the vehicle again restores the steering normally from the changed lane to an original lane, using a feedback controller. In this case, since a function itself controlling the driving of the own vehicle is similar to a function in an electronic control unit (ECU) according to the related art, a detailed description thereof will be omitted.

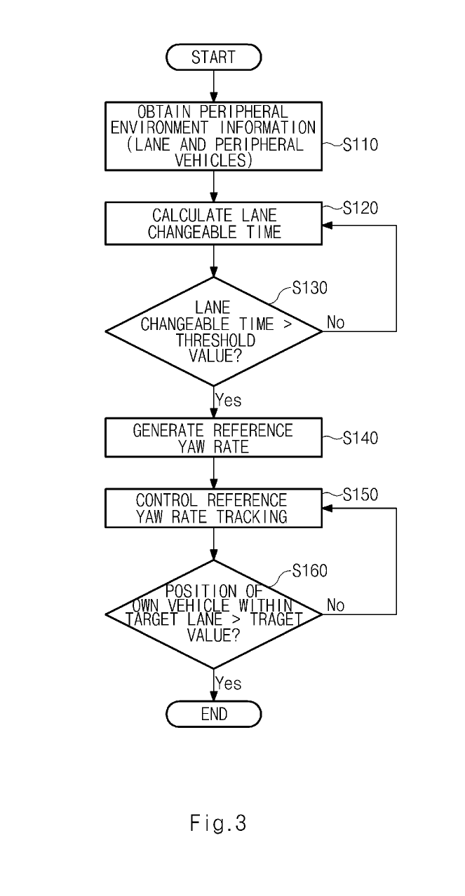

FIG. 3 is a flow chart for describing a lane change method of a lane change control apparatus according to an exemplary embodiment of the present disclosure.

First, the lane change control apparatus obtains information for the surrounding environment of a vehicle (own vehicle) in which it is mounted (S110). For example, the lane information extractor 100 obtains image information for the lane by using a camera 12 and then processes the image information to thereby calculate lane information (a lane width and a curvature) for a driving lane. The lane changeable time calculator 200 checks positions and speeds of peripheral vehicles positioned around the own vehicle on the driving lane and the target lane by using the obstacle sensing sensor 14 such as, the RiDAR sensor, the radar sensor, and the ultrasonic sensor, and compares the positions and speeds with a speed of the own vehicle to thereby calculate relative speeds of the own vehicle and peripheral vehicle around the own vehicle and distances between the own vehicle and peripheral vehicles.

In the case in which information for the surrounding environment is obtained, the lane changeable time calculator 200 calculates a lane changeable time by using the relative speeds of the own vehicle and other vehicles around the own vehicle and the distances between the own vehicle and peripheral vehicles (S120). For example, the lane changeable time calculator 200 may determine safety for changing the lane using any one of the known methods, such as a minimum safety spacing (MMS) algorithm or a time to collision (TTC) algorithm, and calculates the time capable of safely changing the lane without being collided with the peripheral vehicles.

Next, the lane changeable time calculator 200 compares the calculated time with the preset threshold value to thereby check whether or not the lane changeable time is larger than the threshold value (S130). If the lane changeable time is larger than the threshold value, the lane changeable time calculator 200 transmits information for the lane changeable time to the reference yaw rate generator 300 while informing the reference yaw rate generator 300 that the lane changeable time is larger than the threshold value. If the lane changeable time is smaller than the threshold value, the lane changeable time calculator 200 repetitively performs the calculation of the lane changeable time.

If the reference yaw rate generator 300 receives information for the lane changeable time from the lane changeable time calculator 200, it generates the reference yaw rate by using the lane changeable time, the lane information, and the speed information (S140). For example, the reference yaw rate generator 300 may determine the lane change time so as to correspond to the speed of the own vehicle within the lane changeable time and may then generate the reference yaw rate so that the own vehicle may drive (change the lane) along the sine wave shape having amplitude as the lane width and a half of period as the lane change time. Alternatively, the reference yaw rate generator 300 may generate the reference yaw rate by predetermining and storing the yaw rate according to the speed and the curvature of the own vehicle using the driving data which is actually measured, extracting (selecting) the current speed and curvature of the own vehicle, and applying the positive (+) value to the extracted yaw rate during the first half time of the lane change time and applying the negative (−) value to the extracted yaw rate during the remaining half time. It the reference yaw rate is generated, the reference yaw rate generator 300 transmits information for the generated reference yaw rate to the reference yaw rate tracker 400.

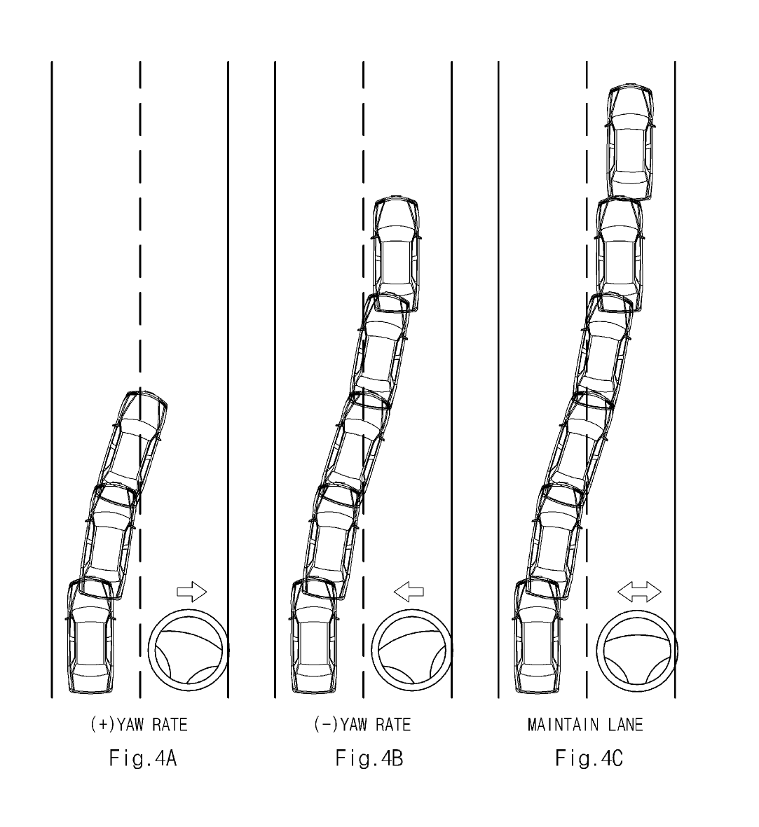

If the reference yaw rate tracker 400 receives information for the reference yaw rate from the reference yaw rate generator 300, it controls an operation of the own vehicle so that the own vehicle may robustly track the corresponding reference yaw rate (S150). For example, the reference yaw rate tracker 400 moves the own vehicle to a right direction (a target lane direction) by adjusting a steering wheel to a right side so as to track the positive (+) yaw rate during the first half time in the lane change time as shown in FIG. 4A. The reference yaw rate tracker 400 then adjusts the steering wheel to a left side so as to track the negative (−) yaw rate during the remaining half time in the lane change time as shown in FIG. 4B. The above-mentioned tracking control may compare an actual yaw rate of the own vehicle at the time of the lane change with the reference yaw rate by using a yaw rate sensor (not shown) to thereby continuously monitor whether or not the vehicle tracks the reference yaw rate normally and may track the reference yaw rate by feedbacking an error at the time of an error occurrence and reflecting the feedback error to the operation control of the vehicle. Therefore, the steering of the vehicle within the target lane after lane change time is elapsed becomes equal to the steering of the vehicle within the driving lane before the lane change, and the vehicle may maintain the target lane as shown in FIG. 4C.

While the tracking control for the reference yaw rate is performed, the reference yaw rate tracker 400 checks whether or not the own vehicle enters the target lane or normally arrives at a targeted position normally within the target lane by continuously monitoring the position of the own vehicle using position information of the own vehicle from the lane information extractor 100. When the corresponding condition is satisfied, the lane change control is terminated (S160).

According to the exemplary embodiment of the present disclosure, the lane may be simply and stably changed without requiring complex parameters and performing a cumbersome pre-process such as a system identification.

The exemplary embodiments of the present disclosure described above have been provided for illustrative purposes. Therefore, those skilled in the art will appreciate that various modifications, alterations, substitutions, and additions are possible without departing from the scope and spirit of the disclosure as disclosed in the accompanying claims and such modifications, alterations, substitutions, and additions fall within the scope of the present disclosure.

What is claimed is:

1. A lane change control apparatus, comprising:
a lane information extractor configured to obtain lane information for a driving lane by using image information for a lane;
a lane changeable time calculator configured to calculate a lane changeable time by using speed information of an own vehicle and information for peripheral vehicles obtained from sensing apparatuses installed in the own vehicle;
a reference yaw rate generator configured to determine a lane change time by using the lane changeable time and the speed information and generate a reference yaw rate symmetrically changed on a time axis during the lane change time by using the lane changeable time and the lane information; and
a reference yaw rate tracker configured to control an operation of the own vehicle so as to track the reference yaw rate.

2. The lane change control apparatus according to claim 1, wherein the lane changeable time calculator calculates a relative speed of the own vehicle and a peripheral vehicle in front of a driving lane and a distance between the own vehicle and the peripheral vehicle in the front of the driving lane, calculates relative speeds of the own vehicle and peripheral vehicles in front and back of a target lane and distances between the own vehicle and the peripheral vehicles in the front and back of the target lane, and calculates the lane changeable time by using the calculated relative speeds and distances.

3. The lane change control apparatus according to claim 2, wherein the lane changeable time calculator calculates the lane changeable time by using a minimum safety spacing (MMS) algorithm or a time to collision (TTC) algorithm.

4. The lane change control apparatus according to claim 1, wherein the reference yaw rate generator variably determines the lane change time according to the speed information.

5. The lane change control apparatus according to claim 1, wherein the reference yaw rate generator generates the reference yaw rate by applying a yaw rate during a first half time in the lane change time and a yaw rate during the remaining half time, having a same magnitude, to opposite directions.

6. The lane change control apparatus according to claim 1, wherein the reference yaw rate generator generates the reference yaw rate so that the own vehicle drives along a sine wave shape having an amplitude as a lane width and a half of period as the lane change time.

7. The lane change control apparatus according to claim 1, wherein the reference yaw rate generator selects any one of pre-stored reference yaw rates according to the speed information, the lane change time, and the lane information.

8. The lane change control apparatus according to claim 1, wherein the lane information extractor detects a position of the own vehicle on a current lane by using the image information.

9. The lane change control apparatus according to claim 8, wherein the reference yaw rate tracker monitors whether or not the own vehicle is positioned within a target lane by using position information of the own vehicle from the lane information extractor.

10. The lane change control apparatus according to claim 1, wherein the reference yaw rate tracker compares an actual yaw rate of the own vehicle at the time of the lane change and the reference yaw rate to thereby monitor whether or not the own vehicle tracks the reference yaw rate normally and feedbacks an error at the time of an error occurrence to thereby reflect the feedback error to the operation control of the own vehicle.

11. A lane change control method of a vehicle, the method comprising steps of:
obtaining lane information by using image information of a lane and obtaining speed information of an own vehicle and relative speeds and distances between peripheral vehicles and the own vehicle by using information from sensing apparatuses installed in the own vehicle;
calculating a lane changeable time by using the relative speeds and the distances;
determining a lane change time by using the lane changeable time and the speed information of the own vehicle and generating a reference yaw rate symmetrically changed on an time axis during the lane change time by using the lane changeable time and the lane information; and
controlling an operation of the own vehicle so as to track the reference yaw rate.

12. The method according to claim 11, wherein the reference yaw rate has a yaw rate during a first half time in the lane change time and a yaw rate during the remaining half time, having a same magnitude but applied to opposite directions.

13. The method according to claim 12, wherein the reference yaw rate is a yaw rate allowing the own vehicle to be driven along a sine wave shape having an amplitude as a lane width and a half of period as the lane change time.
